(19) United States
(12) Patent Application Publication
(10) Pub. No.: US 2020/0230450 A1
(43) Pub. Date: Jul. 23, 2020

(54) Method and Device for Producing an Extinguishing Foam Containing an Extinguishing Gas

(71) Applicant: Minimax GmbH & Co. KG, Bad Oldesloe (DE)

(72) Inventors: Evert JONKER, Vaassen (NL); Marcel RUESINK, Harbrinkhoek (NL); Joachim BÖKE, Düsseldorf (DE); Stephan ROLAND, Bad Urach (DE); Michael HARNACK, Beckum (DE)

(21) Appl. No.: 16/634,880

(22) PCT Filed: Jul. 31, 2018
(86) PCT No.: PCT/EP2018/070812

§ 371 Date: Jan. 28, 2020

(30) Foreign Application Priority Data
Aug. 1, 2017 (DE) 10 2017 117 412.5

(51) Int. Cl. A62C 5/02

(52) U.S. Cl. CPC A62C 5/024

(57) ABSTRACT

The present invention relates to a method for producing compressed-air foam and to a corresponding device. The method comprises providing fire-fighting water admixed with foaming agent, and foaming the fire-fighting water admixed with foaming agent, with addition of compressed gas, wherein the compressed gas comprises a chemical extinguishing agent. The method according to the invention and the device according to the invention allow the production of an effective extinguishing foam due to the inhibitory effect of the chemical extinguishing agent.

### PRIORITY CLAIM AND INCORPORATION BY REFERENCE

This application is a 35 U.S.C. § 371 application of International Application No. PCT/EP2018/070812, filed Jul. 31, 2018, which claims the benefit of German Application No. 10 2017 117 412.5 filed Aug. 1, 2017, each of which is incorporated by reference in its entirety.

### TECHNICAL FIELD

The present invention relates to a method and a device for producing compressed-air foam, in particular for fighting fires and/or for mitigating consequences of release.

### BACKGROUND AND SUMMARY OF THE INVENTION

The invention relates in particular to such a method or such a device for which fire-fighting water admixed with foaming agent is provided and the fire-fighting water admixed with foaming agent is foamed with addition of compressed gas. Methods and devices of said type are known for producing so-called compressed-air foam (CAF).

In the prior art, it is known to use different types of extinguishing foam for different fires. In particular for fires with flammable liquids, for example liquefied gas, the use of extinguishing foams is desirable since the burning pool of liquid is covered by the foam layer and the supply of oxygen can thereby be separated therefrom.

Generally, use has hitherto been made of heavy-foam extinguishing systems and light-foam extinguishing systems, which differ from one another by the foaming number, that is to say ratio of the volume of the foam to the volume of the fire-fighting water used. In this case, it is known that use is made of medium- and heavy-foam extinguishing systems in particular for C3 to C4 hydrocarbons and of light-foam extinguishing systems for example for liquefied natural gas (LNG).

Heavy foam introduces a high amount of energy into the pools, for example of liquefied gas, due to the high water content in the foam and also due to water precipitating from the foam, which results in a high evaporation rate. Medium foam and light foam are likewise used, but are able to control the fire only over a limited period of time since the foam is destroyed by the fire. There are also difficulties in applying this foam uniformly over the pool over very large areas in a correspondingly short period of time.

In other words, in particular in the case of light foam outside closed rooms, there are difficulties, for example in the case of wind, in applying the foam to the pool in a surface-covering manner, since the foam is light, that is to say has a low density, and is thus susceptible to air and wind resistance. Also, the foam layer generally does not endure over an extensive period of time since, for example, it is destroyed by the fire. When the foam layer loses its sealing action, the fire is again fed by oxygen which reaches the fire and effective fire-extinguishing is hindered.

The CAFs mentioned in the introduction constitute one attempt to eliminate these disadvantages, and provide a stable foam despite a low quantity of energy or of fire-fighting water. Methods and devices for producing compressed-air foam are known for example from the European patent EP 1 789 143 B1. Here, a main water stream is mixed with a foam-former stream and the water/foam-former mixture is subjected to a compressed-air stream in a foaming section, wherein, in the foam-former stream and/or the main water stream, at least one in particular fire-specific additive, which is adapted to the respective case of use, is injected.

US 2011/0127051 A1 relates to a compressed-air foam system which comprises one or more optional fluid pumps, one or more mixer devices, one or more optional foam systems, one or more optional gas compressors and a system controller. A method for using the compressed-air foam system is also described.

US 2003/0047327 A1 relates to a fire suppression device having a nozzle, which allows variable air mixing, and to a method for producing a foam discharge with such a nozzle.

WO 2011/085208 A2 relates to a foaming tube for a fire-fighting nozzle having a tubular body with a longitudinal axis and a passage path extending therethrough, which is configured to direct a mixture of foam and water from a fire-fighting nozzle. The passage has a larger diameter than the nozzle outlet in order that an expansion tube is provided for the foam/water mixture.

Proceeding from this technology, it was an object of the present invention to specify an improved method and an improved device for producing compressed-air foam, which allows improved fire-fighting and/or mitigation of consequences of release.

According to the invention, the object is achieved with a method or a device for producing compressed-air foam of the type mentioned in the introduction by the features of the characterizing parts of the independent claims.

In a first aspect, the object is achieved by a method for producing compressed-air foam, wherein the method comprises providing fire-fighting water admixed with foaming agent and foaming the fire-fighting water admixed with foaming agent, with addition of compressed gas. The compressed gas comprises a chemical extinguishing agent.

Compressed foam, such as for example CAF, provides less input of energy for example into pools of liquefied gas since, in comparison with heavy foam, less water is contained in the foam. The fact that, in particular owing to the advantageous drainage properties, less water precipitates from the foam means that less energy is introduced into pools of liquefied gas. By reducing the heat input, the method according to the invention ensures a reduction in the evaporation due to the foam layer.

With the application of a chemical extinguishing agent, which is in particular contained in the compressed gas, it becomes possible to interrupt the chain reaction of the fire. Generally, part of the foam is destroyed by the fire. The destruction of the foam then leads to the release of the additional extinguishing agent, which is contained in the bubbles of the foam.

The principle of the chemical extinguishing agent is to interrupt the chain reaction of the combustion. By contrast to the use of agents which do not act chemically, such as for example inert gas, including carbon dioxide, argon, nitrogen, etc., what is achieved therefore is not oxygen displacement but rather fire-fighting based on the chemical effect of the chemical agent. In comparison with the known displacement solutions, a chemical extinguishing agent requires a significantly lower concentration and is thus able to be applied more easily, even over a large area, for example of a pool of liquid. A combination of the chemical extinguishing agent for example with inert gases for oxygen displacement is also able to be used advantageously in some embodiments.

The fire-fighting water admixed with foaming agent may either be provided as part of the method by admixing foaming agent with the fire-fighting water, or be provided already in pre-mixed form, for example in a tank. The fire-fighting water admixed with foaming agent may also be referred to as an extinguishing agent on the basis of the known linguistic usage.

In one embodiment, the chemical extinguishing agent comprises a chemical extinguishing powder.

Chemical extinguishing powders, such as for example from powder extinguishing systems, are particularly suitable for inhibiting combustion. The chemical extinguishing powders are in particular those extinguishing powders of fire classes B and C, which bring about an inhibition, that is to say an anticatalytic extinguishing effect.

A compressed-air foam produced with the production method according to the invention thus contains in the air chambers or air bubbles, which are surrounded by the fire-fighting water admixed with foaming agent, a chemical extinguishing powder or some other type of chemical extinguishing agent, for example a chemical extinguishing gas, which is released upon destruction of the compressed-air foam and promotes inhibition of the flames. Thus, the compressed-air foam according to the invention demonstrates an increased fire-fighting effect, specifically through the combination of the extinguishing effect of the foam and the inhibition effect of the chemical agent.

In one embodiment, the compressed gas further comprises an inert gas and/or air. In addition to the chemical agent, the compressed air can accordingly comprise for example ambient air or preferably any known inert gas for fire-fighting.

The advantage of ambient air is in the ease of production, for example at the place of production of the compressed-air foam via a compressor. Production of inert gas on site, for example by a nitrogen producer, is also possible. By contrast, inert gases exhibit increased fire-protection efficiency since, upon destruction of the foam, they create a locally inert environment which is effective in particular in combination with the foam and the chemical extinguishing agent.

In one embodiment, the step of foaming is formed in two stages in the flow direction of the fire-fighting water admixed with foaming agent.

In a first foaming, the fire-fighting water admixed with foaming agent is conducted through an aerator. The aerator is preferably formed as a sieve with an external gas feed or else as a siphon with or without a gas feed, but may also have any desired other suitable form.

In a second foaming, the compressed gas is added. The fact that the compressed gas is supplied in a second foaming means that a particularly good distribution of the chemical extinguishing agent in the compressed-air foam is made possible. At the same time, a particularly resistant and at the same time light foam, that is to say with a relatively low fire-fighting water content, is provided. In particular, the second stage of the foaming and the possibility of regulating the admixed gas quantity make it possible for the desired properties of the foam to be set. Instead of the two-stage foaming, in other embodiments, merely one-stage foaming or else foaming with more than two stages is also possible.

In one embodiment, the fire-fighting water admixed with foaming agent is foamed during a foaming section. The compressed gas is added in a portion of the foaming section that has an increasing cross section.

A portion of the foaming section in which the cross section increases improves the foaming, since the cross section increases and thus, at the same flow speed, a larger volume of the then foamed extinguishing agent is made possible. Particularly in the region in which the cross section increases, the extinguishing foam can be suitably influenced by the introduction of the compressed gas.

In one embodiment, the compressed gas is supplied via multiple nozzles, which are arranged on the portion having an increasing cross section.

The multiple nozzles allow, in particular together with the valves arranged in the supply means, precise control of the admixing of the chemical extinguishing agent and of the setting of the state of the foam and of the foaming. In the area of CAF, a state of the foam refers in particular to wet to dry. The control of the valve(s) with the nozzles and thus the introduction of the compressed gas or the chemical extinguishing agent can be adapted to the requirements for the actual fire or the hazards of the place of use, such as for example to the covering of the pool for minimization of evaporation or to the fire-fighting.

In one embodiment, the fire-fighting water is provided via a fire-fighting water line, and the foaming agent is admixed with the fire-fighting water via a foaming agent-admixing component which is situated in the path of the fire-fighting water line. The foaming agent-admixing component is in particular a Venturi nozzle, but may also be designed differently in other embodiments. For example, the foaming agent may also be mixed with the fire-fighting water owing to the gravitational force or by means of a pump. In other embodiments, the fire-fighting water already mixed with the foaming agent may also be provided, for example in a tank.

In one embodiment, a selectively adapted additive is additionally added to the fire-fighting water. The additive allows the fire-fighting effect of the extinguishing foam to be further improved.

According to the invention, the object is further achieved, according to a second aspect, by a method for producing compressed foam, wherein the method comprises providing fire-fighting water admixed with foaming agent and foaming the fire-fighting water admixed with foaming agent, with addition of compressed gas. The step of foaming is formed in two stages in the flow direction of the fire-fighting water admixed with foaming agent, wherein, in a first foaming, the fire-fighting water admixed with foaming agent is conducted through a aerator, in particular a siphon-like gas mixing-in means or a gas supply means with adjoining screen, and wherein, in a second foaming, the compressed gas is added.

According to this aspect, improved fire-fighting or mitigation of consequences of release is already achieved by the two-stage foaming without particular requirements for the compressed gas. It is nevertheless also possible for the method according to this aspect also to be combined with the compressed gas having the chemical extinguishing agent and/or with one of the embodiments described with regard to the first aspect, so as to improve the fire-fighting or to further mitigate the consequences of the release.

According to the invention, the object is further achieved, according to a third aspect, by a method for fighting fires and/or for mitigating fault consequences, wherein the method comprises use of a compressed-air foam produced according to the first or second aspect.

According to a fourth aspect, the object is furthermore achieved by a device for producing compressed-air foam. The device has a fire-fighting water inflow component for the supply of fire-fighting water, a foaming agent-admixing component for the admixing of foaming agent with the fire-fighting water and a foaming component for the foaming of the fire-fighting water admixed with foaming agent, with the addition of compressed gas. The compressed gas comprises a chemical extinguishing agent.

With the device according to the invention, it is thus possible to produce compressed-air foam according to the method according to the first aspect, and all the advantages described in connection therewith are also achievable with the device according to this aspect. Likewise, all the particular and preferred embodiments of the method according to the first aspect are also analogously transferable to the device according to the third aspect.

In one embodiment of the device, the flow component has a first foaming component which has a jet regulation component for the foaming of the fire-fighting water admixed with foaming agent, and has a second foaming component for the addition of the compressed gas.

The foaming component according to this embodiment thus allows the two-stage, advantageous foaming. The jet regulation component is preferably formed as a sieve. According to the pressure conditions, the first foaming component is preferably alternatively or additionally designed as a chamber with a slightly higher external pressure, in order that gas/air admixing can always be realized here.

In one embodiment of the device, the second foaming component has a foaming section which has an increasing cross section, wherein the second foaming component has at least one valve and multiple nozzles, via which the compressed gas is able to be supplied and which are arranged on the portion of the foaming section having an increasing cross section.

The fact that the multiple nozzles are arranged precisely in the portion in which the cross section of the flow section increases means that a particularly effective introduction of the compressed gas is possible.

In particular, it is possible via regulation of the admixing of the gas for the exact composition or the state of the final foam, including the concentration of the chemical extinguishing agent therein, to be defined. In this way, the device can be appropriately set according to requirements for the fire or the evaporation reduction/cooling.

In one embodiment of the device, the multiple nozzles are arranged rotationally symmetrically about a central axis of the foaming section.

The rotationally symmetrical arrangement makes possible a particularly uniform distribution of the compressed gas in the foam produced.

In one embodiment of the device, the multiple nozzles are arranged in multiple planes axially in relation to a flow direction of the foaming section.

Multiple different nozzles are thereby automatically also arranged at places which have a different cross section of the flow section, since the nozzles are arranged precisely in the region in which the cross section of the foaming section increases. Owing to the multiple axial positions of the nozzles, the distribution of the compressed gas in the foam, and thus the foam produced, are further improved.

In one embodiment, the device is designed for mobile use. This makes it possible for the device to be transported as close as possible to the location of the fire, and thus for the pressurized foam to be produced in the immediate vicinity of the planned place of use. In other embodiments, the device may of course also be mountable in a stationary manner.

In a further aspect, the object is achieved by a device for producing compressed-air foam, wherein the device has a fire-fighting water inflow component for the supply of fire-fighting water, has a foaming agent-admixing component for the admixing of foaming agent with the fire-fighting water, and has a foaming component for the foaming of the fire-fighting water admixed with foaming agent, with the addition of compressed gas. The foaming component has a first foaming component which has a jet regulation component for the foaming of the fire-fighting water admixed with foaming agent, in particular a siphon-like gas mixing-in means or a gas supply means with adjoining screen, and a second foaming component for the addition of the compressed gas.

According to this aspect too, improved fire-fighting or mitigation of consequences of release is already achieved by the two-stage foaming without particular requirements for the compressed gas. It is nevertheless also possible for the device according to this aspect also to be combined with the compressed gas having the chemical extinguishing agent and/or with one of the embodiments described with regard to the further aspects, so as to improve the fire-fighting or to further mitigate the consequences of the release.

In a further aspect of the present invention, the object is achieved by use of a device for producing compressed-air foam, wherein a compressed gas which comprises a chemical extinguishing agent is used with the device.

Consequently, the advantageous effects according to the invention can also be obtained in known devices for producing compressed-air foam if these are operated with a compressed gas which comprises a chemical extinguishing agent. In other words, it is advantageous if, in known devices for producing compressed-air foam, the compressed-air canister or the compressed-air production is replaced in that use is made of a chemical extinguishing agent, that is to say an agent which makes inhibition of the flames possible.

Exemplary embodiments of the present invention will be described in detail below with reference to the accompanying figures. In the figures:

### BRIEF DESCRIPTION OF THE DRAWINGS

FIG. 1 shows, schematically in cross section, a device according to the invention for producing compressed-air foam.

FIG. 2 shows, in a perspective schematic view, a further embodiment of a device for producing compressed-air foam according to a method according to the invention.

### MODE(S) FOR CARRYING OUT THE INVENTION

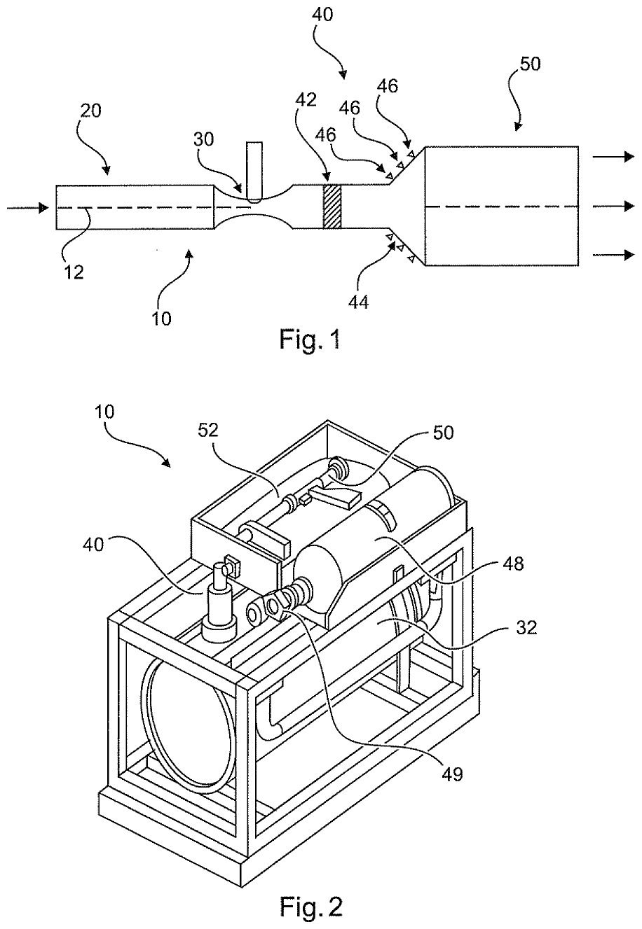

FIG. 1 shows, in cross section or schematically in a side view, a device 10 for producing compressed-air foam. The cross section in FIG. 1 shows a flow path of the fire-fighting water along a central axis 12 of the device 10 from left to right, wherein this course, self-evidently, is not fixed with respect thereto and may also run differently, in particular in a curved manner, etc.

The device 10 has a fire-fighting water inflow component 20 for the supply of fire-fighting water. In the present example, a fire-fighting water hose or the like may be connected for example to the fire-fighting water inflow component 20 on the left-hand side.

In the flow path of the fire-fighting water, the fire-fighting water inflow component 20 is adjoined by a foaming agent-admixing component 30 for the admixing of foaming agent with the fire-fighting water. In the example, the foaming agent-admixing component 30 is designed as a Venturi nozzle, wherein the foaming agent is sucked in by negative pressure via an opening in the narrowed cross section of the Venturi nozzle during the throughflow of the fire-fighting water. Other configurations of the foaming-agent admixing means, which differ from the example shown of the foaming agent-admixing component 30, are also conceivable. In other examples, the fire-fighting water admixed with foaming agent may also already be provided in a suitable container (cf. FIG. 2), or the admixing may be realized by way of a pump or bladder tank without a Venturi.

In the flow path, the foaming agent-admixing component 30 is adjoined by a foaming component 40 for the foaming of the fire-fighting water admixed with foaming agent, with the addition of compressed gas. The foaming component 40 is of two-stage design, wherein firstly, a first foaming component 42 produces a first foaming. The first foaming component 42 has for example a screen or a chamber with a slightly higher external pressure, wherein the chamber ensures that gas/air admixing is always realized.

The first foaming component is adjoined by a second foaming component 44 for the addition of the compressed gas. The second foaming component 44 integrates a foaming section having an increasing cross section, with the result that widening of the diameter meanwhile occurs, which improves foaming.

In the region of the second foaming component 44, there are arranged multiple valves 46 through which the compressed gas, which comprises chemical extinguishing agent, is supplied. In the present example, the nozzles 46 are arranged in three axially parallel planes, for which in each case one valve 46 is shown indicated on an upper and a lower side of the cross section. The number and arrangement of the nozzles 46 are of course not limited thereto, wherein the nozzles 46, which are arranged preferably rotationally symmetrically about the central axis 12, make possible particularly uniformly produced extinguishing foam. Finally, the device 10 has a dispensing component 50, which is configured for the dispensing of the foamed extinguishing foam.

FIG. 2 shows, in a perspective schematic view, a device 10 for producing compressed-air foam. A dispensing component 50 designed as an extinguisher pistol, which is able to be removed from the housing shown via an extinguisher hose 52, can be seen.

An extinguishing-agent container 32 and an extinguishing-gas container 48 are connected to the dispensing component 50 via a mixing chamber head, which performs the function of the foaming component 40, via the extinguisher hose 52. An extinguishing gas which comprises a chemical extinguishing agent is already contained in the extinguishing-gas bottle 48 or is able to be introduced therein. The compressed gas contained in the extinguishing-gas bottle 48 acts as a blowing agent for the foaming, for example for the content of the extinguishing-agent container 32.

In the present example, the fire-fighting water admixed with foaming agent is already contained in the extinguishing-agent container 32. In other embodiments, it is also possible for a fire-fighting water supply means to be connected to the component designed as a mixing head, which then acts as a foaming agent-admixing component 30. By suitable modification or adaptation of an existing CAF device, it is thus possible for the advantage of the solution according to the invention to be achieved by replacing the compressed gas with a gas comprising a chemical extinguishing agent.

### LIST OF UTILIZED REFERENCE NUMBERS

10 Device
12 Central axis
20 Fire-fighting water inflow component
30 Foaming agent-admixing component
32 Extinguishing-agent container
40 Foaming component
42 First foaming component
44 Second foaming component
46 Nozzle
48 Extinguishing-gas container
50 Dispensing component
52 Extinguisher hose

1. A method for producing compressed-air foam, wherein the method comprises:
providing fire-fighting water admixed with foaming agent,
foaming the fire-fighting water admixed with foaming agent, with addition of compressed gas, wherein the compressed gas comprises a chemical extinguishing agent.

2. The method as claimed in claim 1, wherein the chemical extinguishing agent comprises a chemical extinguishing powder.

3. The method as claimed in claim 1, wherein the compressed gas further comprises an inert gas or air.

4. The method according to claim 1, wherein the step of foaming is formed in two stages in the flow direction of the fire-fighting water admixed with foaming agent, wherein,
in a first foaming, the fire-fighting water admixed with foaming agent is conducted through an aerator having a siphon-like gas mixing-in means or a gas supply means with adjoining screen, and wherein,
in a second foaming, the compressed gas is added.

5. The method as claimed in claim 4, wherein the fire-fighting water admixed with foaming agent is foamed during a foaming section, wherein the compressed gas is added in a portion of the foaming section that has an increasing cross section, wherein the compressed gas is supplied via multiple nozzles, which are arranged on the portion having an increasing cross section.

6. The method as claimed in claim 5,
wherein the compressed gas is supplied via multiple nozzles, which are arranged on the portion having an increasing cross section and are arranged in multiple planes axially in relation to a flow direction of the foaming section.

7. The method as claimed in claim 1, wherein the fire-fighting water is provided via a fire-fighting water line, and wherein the foaming agent is admixed with the fire-fighting water via a foaming agent-admixing component which is situated in the fluid path of the fire-fighting water line, and wherein the foaming agent-admixing component includes a Venturi nozzle.

8. A method for fighting fires and/or for mitigating fault consequences, which comprises use of a compressed-air foam produced according to claim 1.

9. A device for producing compressed-air foam, wherein the device comprises:
a fire-fighting water inflow component for the supply of fire-fighting water,
a foaming agent-admixing component for the admixing of foaming agent with the fire-fighting water,
a foaming component for the foaming of the fire-fighting water admixed with foaming agent, with the addition of compressed gas,
wherein the foaming component is arranged for addition of the compressed gas comprising a chemical extinguishing agent.

10. The device as claimed in claim 9, wherein the foaming component comprises:
a first foaming component which has a jet regulation component for the foaming of the fire-fighting water admixed with foaming agent including a siphon-like gas mixing-in means or a gas supply means with adjoining screen, and
a second foaming component for the addition of the compressed gas.

11. The device as claimed in claim 10, wherein the second foaming component has a foaming section which has an increasing cross section, and wherein the second foaming component has multiple nozzles, via which the compressed gas is able to be supplied and which are arranged on the portion of the foaming section having an increasing cross section.

12. The device as claimed in claim 11, wherein the multiple nozzles are arranged rotationally symmetrically about a central axis of the foaming section.

13. The device as claimed in claim 12, wherein the multiple nozzles are arranged in multiple planes axially in relation to a flow direction of the foaming section.

14. (canceled)

15. The device as claimed in claim 9, wherein the device is designed for mobile use.
